(19) United States
(12) Patent Application Publication
(10) Pub. No.: US 2012/0200866 A1
(43) Pub. Date: Aug. 9, 2012

(54) PRINTING APPARATUS, PRINTING METHOD, AND PROGRAM

(75) Inventor: Yuzo Harano, Sagamihara-shi (JP)

(73) Assignee: CANON KABUSHIKI KAISHA, Tokyo (JP)

(21) Appl. No.: 13/355,368

(22) Filed: Jan. 20, 2012

(30) Foreign Application Priority Data
Feb. 3, 2011 (JP) 2011-022013

(51) Int. Cl. H04N 1/60

(52) U.S. Cl. 358/1.9

(57) ABSTRACT

A printing apparatus includes a generation unit configured to identify a print area of a sheet on which a copy material is provided based on a print job, and, regarding the print area, generate image data subjected to other image processing which is other than image processing to be applied to the entire print job and in which an usage amount of a color material applied to the print area is not smaller than a defined value, and a forming unit configured to form an image in the print area by applying the color material according to the image data.

### BACKGROUND OF THE INVENTION

1. Field of the Invention

The present invention relates to a printing apparatus, a printing method, and a program.

2. Description of the Related Art

Conventionally, there are various types of ledger sheet forms including carbonless copy paper capable of copying characters or the like written in specified areas to the next sheet. When such a ledger sheet form including carbonless copy paper capable of copying to the next sheet is created, the form may include an area copying of which is inhibited. In such a case, generally, toner is applied on a back surface of the copy-inhibited area on the carbonless copy paper of the previous page, so that the characters written in the area are not copied to the next page as discussed in Japanese Patent Application Laid-Open No. 2006-185358.

However, if a printing apparatus that employs the electrophotographic method is used in the printing of the form, in some cases, due to the image processing performed, sufficient toner that can prevent the copying is not applied to the back surface of the carbonless copy paper. If sufficient toner is not applied, the conventional technique is not effective in appropriately preventing the copying.

In other words, in printing carbonless copy paper, if copying to the next page is to be inhibited, sufficient toner needs to be applied to such an area. However, an image processing unit of the printing apparatus applies the designated image processing to the whole print job. Such image processing includes processing that reduces the amount of toner to be applied (toner application amount) or reduce the density of the toner considering the image quality or the characteristics of the printing apparatus. Thus, when such image processing is performed, a sufficient amount of toner that can prevent the copying cannot be applied to the corresponding area at the back surface of the carbonless copy paper. Accordingly, copying cannot be appropriately prevented.

### SUMMARY OF THE INVENTION

The present invention is directed to a technique capable of limiting copying appropriately.

According to an aspect of the present invention, a printing apparatus includes a generation unit configured to identify a print area of a sheet on which a copy material is provided based on a print job, and, regarding the print area, generate image data subjected to other image processing which is other than image processing to be applied to the entire print job and in which an usage amount of a color material applied to the print area is not smaller than a defined value, and a forming unit configured to form an image in the print area by applying the color material according to the image data.

According to the present invention, copying can be limited in an appropriate manner.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a printing system.

FIG. 2 illustrates an example of carbonless copy paper.

FIG. 3 illustrates another example of carbonless copy paper.

FIG. 4 illustrates an example of a copy mechanism of carbonless copy paper.

FIG. 5 is a flowchart illustrating an example of printing control processing.

FIG. 6 is a flowchart illustrating another example of the printing control processing.

FIG. 7 illustrates another example of the copy mechanism of the carbonless copy paper.

FIG. 8 illustrates another example of the copy mechanism of the carbonless copy paper.

FIG. 9 is a flowchart illustrating an example of the printing control processing.

### DESCRIPTION OF THE EMBODIMENTS

Various exemplary embodiments, features, and aspects of the invention will be described in detail below with reference to the drawings.

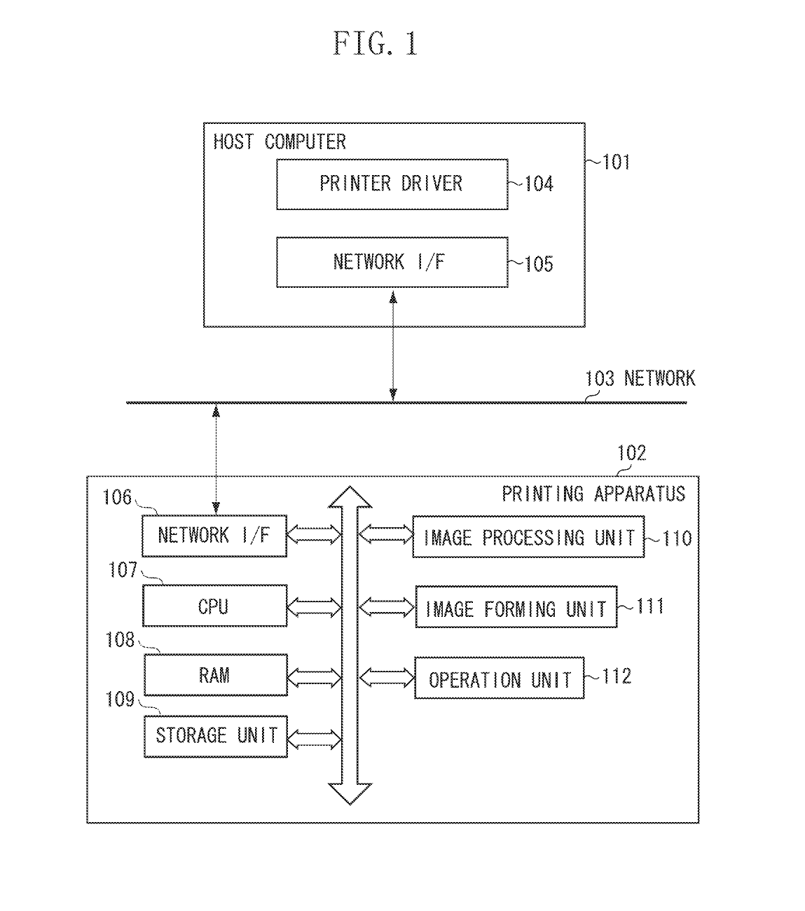

FIG. 1 illustrates an example of a configuration of a printing system according to a first exemplary embodiment. The printing system includes a host computer 101 and a printing apparatus 102. The host computer 101 and the printing apparatus 102 are capable of communicating with each other via a network 103.

The configurations of the printing system according to the present exemplary embodiment are not limited to the configuration described above, and can be configured to have various configurations according to the application and the purpose of the system. For example, the printing system can be a single apparatus, a system including a plurality of apparatuses, or a system connected to a network such as a local area network (LAN) or a wide area network (WAN) to perform processing. The printing system to implement the functions of the exemplary embodiment is not limited to such an example.

The host computer 101 is an example of an information processing apparatus (computer). More specifically, the host computer 101 is an information processing apparatus having a printer driver 104 installed and is connected to the network 103 via a network interface (I/F) 105. According to the present exemplary embodiment, the host computer 101 is described as a personal computer (PC).

The printer driver 104 is software that runs on an operating system (OS) which controls the host computer 101. Further, the printer driver 104 writes print data in a page description language (PDL) according to a print instruction from an application and transmits the print data as a print job to the printing apparatus 102.

The network I/F 105 is used when communication between an external apparatus is performed via the network 103 and performs communication processing on the network 103. For example, the network I/F 105 is used for Internet communication using Transmission Control Protocol/Internet Protocol (TCP/IP) and data transmission/reception between the printing apparatus 102.

The host computer 101 includes general hardware, such as a central processing unit (CPU), a hard disk, a random access memory (RAM), and an input/output device. Since these are general purpose devices, their descriptions are not given.

The printing apparatus 102 is an example of an apparatus (computer) including a network I/F 106, a CPU 107, a RAM 108, a storage unit 109, an image processing unit 110, an image forming unit 111, an operation unit 112, and a system bus. According to the present exemplary embodiment, the printing apparatus 102 is described as a printer. The network I/F 106 is used for communication between the printing apparatus and an external apparatus via the network 103 and controls the communication on the network. The Internet communication using TCP/IP and data transmission/reception between the printing apparatus and the host computer 101 is made possible according to the network I/F 106.

The CPU 107 executes various types of processing such as numerical calculation, information processing, and apparatus control based on various programs which are stored in the storage unit 109 of the printing apparatus 102 and loaded onto the RAM 108. The RAM 108 is a general volatile storage device which can be directly accessed from the CPU 107. The RAM 108 is used as a work area of the CPU 107 and is also used as a temporary data storage area. The storage unit 109 temporarily or permanently stores a print job received from the host computer 101. According to the present exemplary embodiment, the storage unit 109 is described as a hard disk drive.

The image processing unit 110 performs copying, generates print image data by processing a print job written in PDL, and transfers the generated image data to the image forming unit 111. The page description language, such as Post Script (PS) and Printer Control Language (PCL), is a language that describes a command used for controlling a page printer.

Further, when the image processing unit 110 receives a print job, the image processing unit 110 performs image processing on the print job according to a print attribute of the printing apparatus 102, and generates print image data by performing rasterization for each page.

More specifically, when the print job is received, the image processing unit 110 determines whether the use of carbonless copy paper is included in the print job. If the use of carbonless copy paper is included, the image processing unit specifies a back surface of a sheet (print sheet). The back surface of the print sheet is a surface of the carbonless copy paper to which a color former (an example of copy material) is applied. While processing the print job, if the image processing unit 110 determines that the page is the back surface of the carbonless copy paper, the image processing unit 110 processes the input data of the print job so that the density of the toner applied to the page will not be reduced. This processing is different from the image processing applied to the entire print job.

The image forming unit 111 can print raster data being the print image data transmitted from the image processing unit 110. According to the present exemplary embodiment, the image forming unit 111 is described as a printer engine. The image forming unit 111 forms an image on the print sheet based on the raster data, which is generated by the image processing unit 110 according to raster image processor (RIP) processing, and thus, a print product is produced. According to the present exemplary embodiment, toner used in the electrophotographic method is used as an example of a color material for the image formation. However, other materials, such as ink instead of toner, can also be used.

The operation unit 112 is a user interface via which an operator generally operates the printing apparatus 102. According to the present exemplary embodiment, the operation unit 112 is described as a liquid crystal display (LCD) touch panel.

The network 103 is a global network or a local network such as the Internet or the LAN. The network 103 connects the printing apparatus 102 and the host computer 101. A network communication technique represented by TCP/IP is used for the connection.

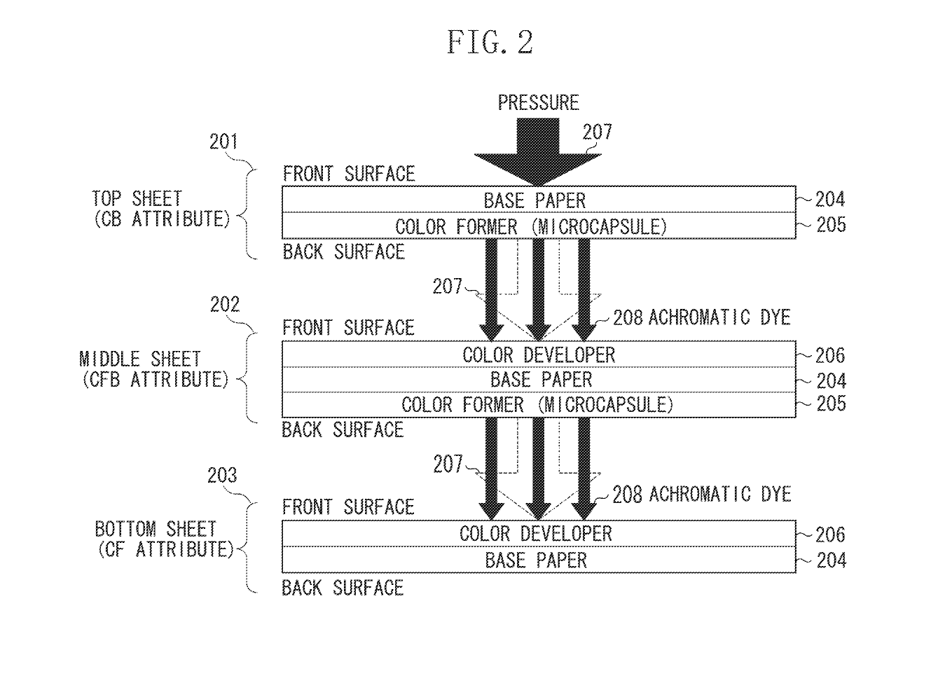

FIG. 2 illustrates an example of the carbonless copy paper used in the present exemplary embodiment. The carbonless copy paper includes three types of sheets, i.e., a top sheet 201, a middle sheet 202, and a bottom sheet 203. The top sheet 201 is referred to as “coated back (CB)”, the middle sheet 202 is referred to as “coated front/back (CFB)”, and the bottom sheet 203 is referred to as “coated front (CF)”.

The top sheet 201 includes base paper 204 and a layer of color former 205. The middle sheet 202 includes a layer of color developer 206, the base paper 204, and a layer of the color former 205. The bottom sheet 203 includes a layer of the color developer 206 and the base paper 204.

The layer of the color former 205 is formed by coating the back surface (first face) of the base paper 204 with microcapsules including an electron-donating color former and drying the coated surface. The layer of the color developer 206 is formed by coating the front surface (second face) of the base paper 204 with an electron-accepting color developer and drying the coated surface.

If a person writes on the surface of the top sheet 201 with a writing instrument such as a pen, copy using the carbonless copy paper is performed. More specifically, a pressure 207 is transferred to the microcapsule of the color former 205 on the back surface of the top sheet. The pressure breaks the microcapsule, and an achromatic dye 208 being the color former soaks out of the microcapsule. The achromatic dye 208 chemically reacts with the color developer 206 on the front surface of the middle sheet 202 and color is delivered. Accordingly, a copy is made. Similarly, the pressure 207 is further transferred to the bottom sheet 203 via the middle sheet 202. By a similar chemical reaction, color is delivered to the bottom sheet 203.

The structure of the carbonless copy paper used in the present exemplary embodiment is not limited to the structure illustrated in FIG. 2. Any type of paper can be used so long as it has the structure of general carbonless copy paper. The carbonless copy paper according to the present exemplary embodiment includes the color former 205 coated on at least one side of a sheet and the color developer 206 coated on at least one side of another sheet. However, as long as the surface of the color former 205 can contact the surface of the color developer 206, the carbonless copy paper of a different structure can also be used. Further, an arbitrary combination of the top sheet 201, the middle sheet 202, and the bottom sheet 203, and an arbitrary number of these sheets can be used.

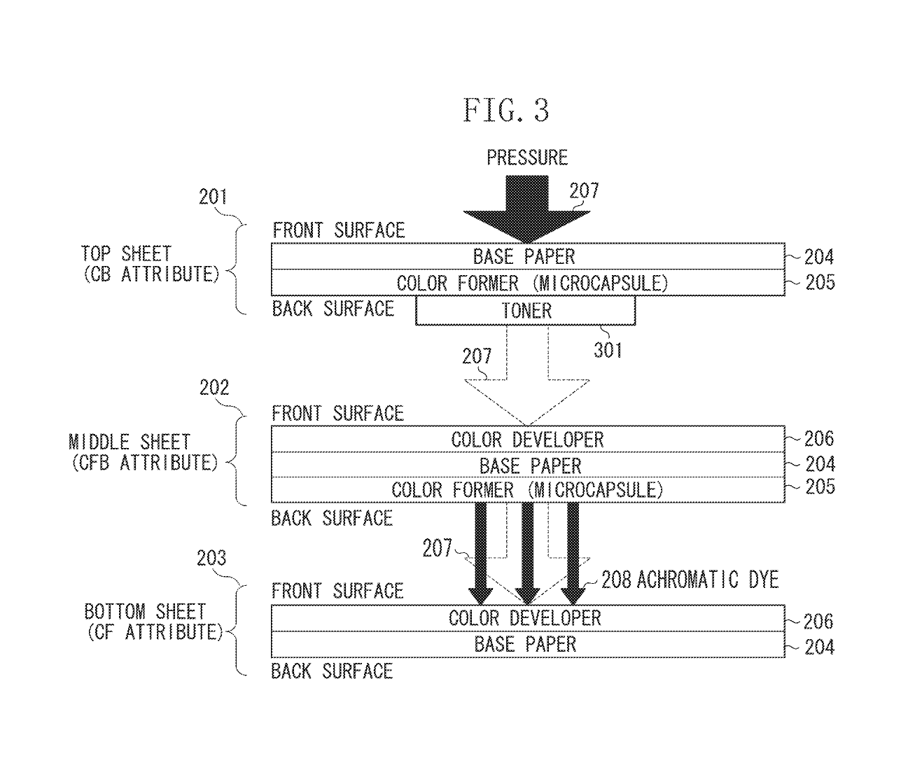

FIG. 3 illustrates an example of the carbonless copy paper. In FIG. 3, toner 301 is applied to the carbonless copy paper by the printing apparatus 102 so that copying is intentionally blocked. Components of the carbonless copy paper with a configuration similar to the paper in FIG. 2 are denoted by the same reference numerals and their descriptions are not repeated.

Regarding the top sheet 201 and the middle sheet 202 of the carbonless copy paper, the toner 301 is applied to a copy-limited (inhibited) area on the back surface of the top sheet 201. Since copy using the carbonless copy paper is based on the chemical reaction of the color former 205 and the developer 206 as described above, a toner layer is formed by the application of the toner 301. Thus, the toner layer can block the contact of the color former 205 and the developer 206.

Whereas, since the toner 301 is not applied to the back surface of the middle sheet 202, the pressure 207 can be transferred to the middle sheet 202 via the top sheet 201, and the copying is performed according to the above-described principle.

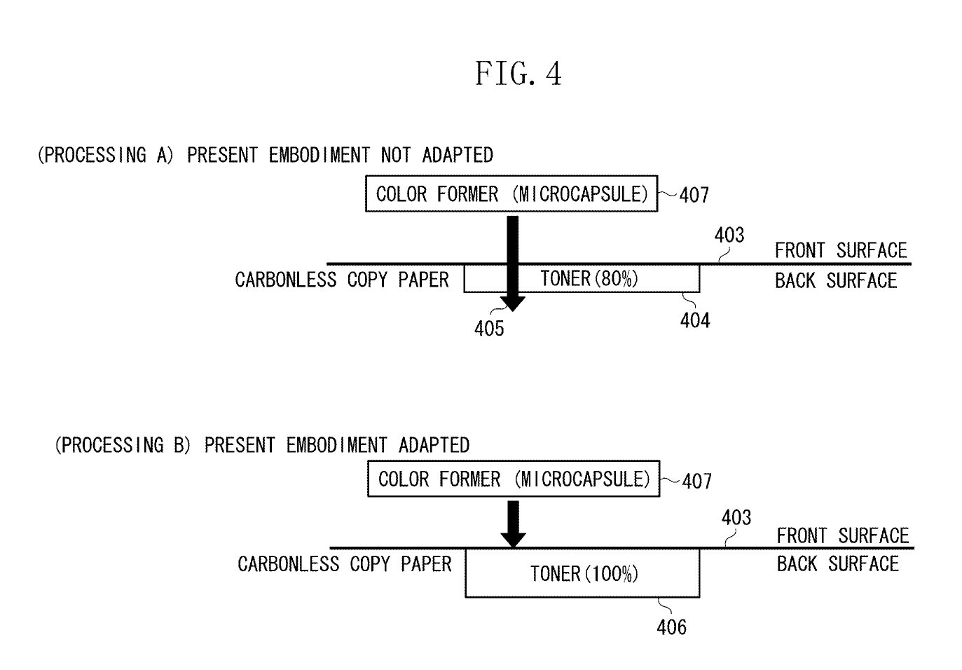

How to realize the blocking of copying of carbonless copy paper is described with reference to FIG. 4. FIG. 4 illustrates an example of a copy mechanism of the carbonless copy paper. Processing A illustrates an example of the conventional case, namely the case in which the present exemplary embodiment is not applied. Processing B illustrates an example of the copy mechanism according to the present exemplary embodiment.

Regarding the processing A, the image processing unit 110 performs the image processing based on the received print job on the entire job regardless of whether the front or the back surface of the carbonless copy paper 403. For example, if a toner save function of reducing usage of the toner is designated by the print job, the image processing unit 110 generates print image data on which such image processing that the toner application amount is reduced in the entire print job is performed. Then, the image forming unit 111 forms an image according to the print image data and applies toner 404 to the copy limited area.

According to the present exemplary embodiment, it is assumed that the toner application amount reduced by the toner save function is 20%. Thus, if the input image signal of the print job is 100%, the final amount of toner application will be 80%. In addition to the toner save function, the processing that reduces the toner application amount may include gradation correction processing, noise reduction processing, smoothing processing, color space conversion processing, and the like. Thus, the processing that reduces the toner is not limited to particular processing in the present exemplary embodiment.

Since the toner 404 finally applied to the page is 80% according to the processing A, the amount of toner is not enough in completely blocking the achromatic dye 405 according to the above-described principle. As a result, some color former passes through the toner layer and chemically reacts with the developer of the next and subsequent carbonless copy paper.

On the other hand, regarding the processing B, if it the sheet to be processed is determined as the back surface of the carbonless copy paper, the reduction processing of the toner application, which is one of the image processing performed for the entire print job, will not be performed on the relevant surface of the paper. Thus, print image data for image processing of high density toner application is generated. Accordingly, the image processing for the toner save function will not be executed, and the toner 406 can be applied to the page with a density of 100% by the image forming unit 111.

In the broader sense, according to the processing B, image processing using toner amount less than a predetermined value (100% in the above-described example) is not performed. Thus, basically, the color former 407 does not pass the toner layer of the toner 406, and the copying can be completely prevented.

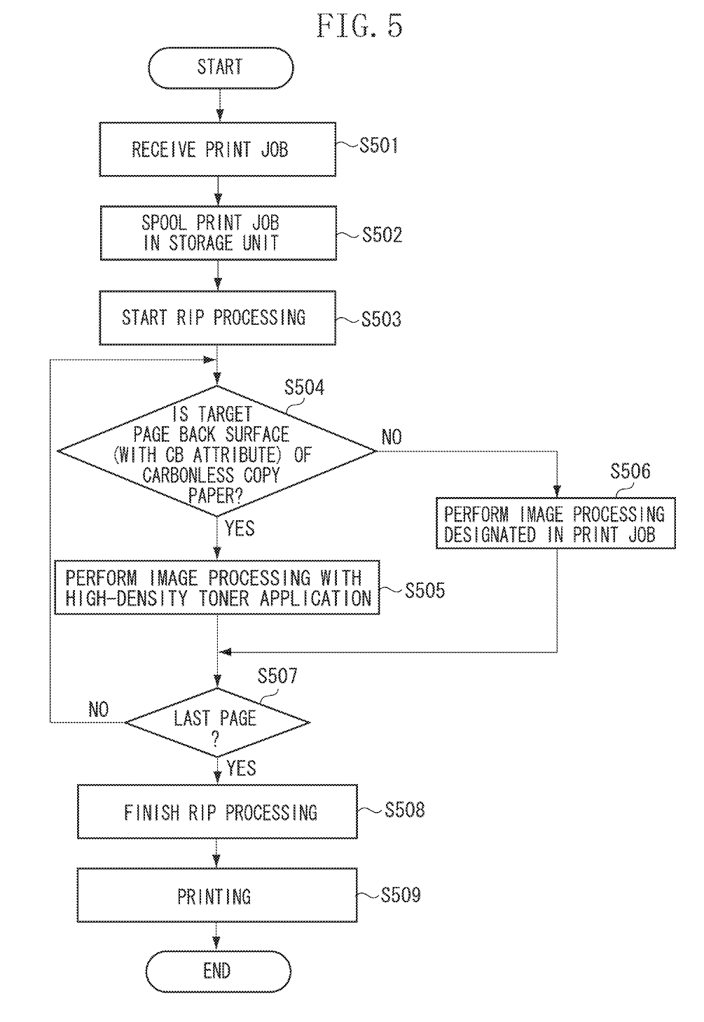

FIG. 5 is a flowchart illustrating an example of print control processing of the printing apparatus 102.

In step S501, the image processing unit 110 receives a print job from the host computer 101 via the network I/F 106 and the control processing is started. In step S502, the image processing unit 110 temporarily spools the print job obtained from the host computer 101 in the storage unit 109.

In step S503, the print processing is started and the image processing unit 110 starts the RIP processing.

In step S504, the image processing unit 110 determines whether the page to be processed (target page), in other words, the target page subjected to the RIP processing, is the carbonless copy paper and the side of the carbonless copy paper is the back surface.

If the image processing unit 110 determines that the target page is the back surface of the carbonless copy paper (YES in step S504), the processing proceeds to step S505. In step S505, the image processing unit 110 performs high density processing. More specifically, the image processing unit 110 generates print image data on which the high density processing is performed with respect to a print portion (an example of a print area) of the target page. The high density processing is the image processing for applying high density toner to the input data of the print job and is different from the image processing applied to the entire print job.

For example, if the image processing unit 110 determines that reduction of the toner application amount is designated by the print job by the toner save function, the image processing unit 110 generates print image data on which the image processing that uses 100% of the toner application amount is performed or print image data on which the image processing that uses a predetermined amount of the toner is performed.

In step S504, if it is determined that the target page is not the back surface of the carbonless copy paper (NO in step S504), the processing proceeds to step S506. In step S506, the image processing unit 110 generates print image data, which is subjected to the image processing to be applied to the entire print job, to the print portion of the target page.

In step S507, when the image processing of the target page ends, the image processing unit 110 determines whether the target page is the last page of the print job. If the image processing unit 110 determines that the target page is the last page (YES in step S507), the processing proceeds to step S508. In step S508, the image processing unit 110 ends the RIP processing to the print job. On the other hand, if the image processing unit 110 determines that the target page is not yet the last page (NO in step S507), the processing returns to step S504 and the RIP processing of the print job is continued.

After the RIP processing ends, in step S509, the image forming unit 111 executes printing of the print image data generated by the image processing unit 110 on the sheet, and then the control processing of the printing apparatus 102 ends.

According to the above-described configuration, the printing apparatus 102 can appropriately block the copying in the copy-inhibited area by sufficiently applying the toner to an area on the back surface of the sheet corresponding to the area where copying to subsequent pages is inhibited in the set of carbonless copy paper.

Next, a second exemplary embodiment of the present invention will be described. According to the present exemplary embodiment, the points different from the first exemplary embodiment will be mainly described and descriptions of similar portions are not repeated.

In some cases, a character of a light color (low density character) is printed on the back surface of the carbonless copy paper. In such a case, if the density of the character is increased as described according to the first exemplary embodiment, a result not intended by the user may be obtained. Thus, according to the present exemplary embodiment, in addition to the processing according to the first exemplary embodiment, the processing is changed according to an object in an area where copying is to be limited.

According to the present exemplary embodiment, the object means an attribute of image data of a print job, such as a text attribute, a graphic attribute, and an image attribute, which are used for a character, a figure, and a photograph. Further, in addition to such attributes, a copy inhibition attribute can be provided for an area where copying to the subsequent page is to be limited in the carbonless copy paper.

According to the present exemplary embodiment, high density image processing is performed on an object corresponding to a back surface of the carbonless copy paper and having an attribute other than the text attribute (an example of a defined attribute). This image processing can also be applied to an object having the copy inhibition attribute. In other words, according to the present exemplary embodiment, the attribute which is subjected to this image processing is not limited and can be changed as appropriate.

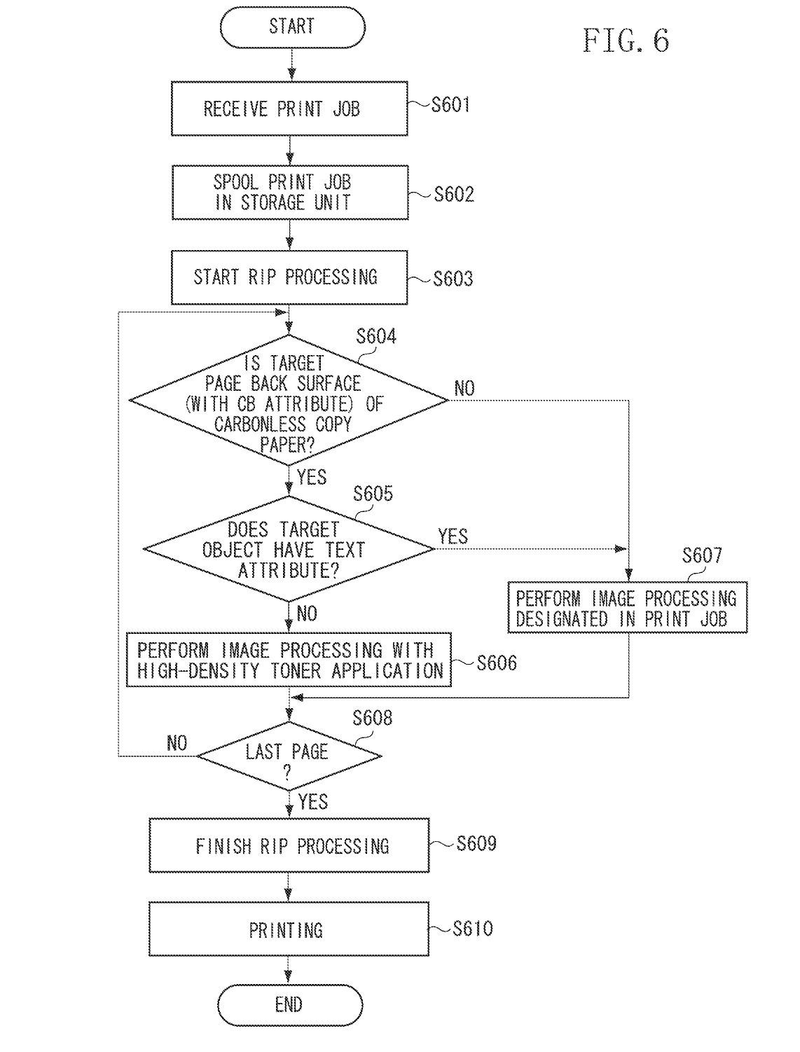

FIG. 6 is a flowchart illustrating an example of print control processing of the printing apparatus 102.

In step S601, the image processing unit 110 receives a print job from the host computer 101 via the network I/F 106 and the control processing is started. In step S602, the image processing unit 110 temporarily spools the print job obtained from the host computer 101 in the storage unit 109.

In step S603, the print processing is started and the image processing unit 110 starts the RIP processing.

In step S604, the image processing unit 110 determines whether the target page subjected to the RIP processing, is the carbonless copy paper and the side of the carbonless copy paper is the back surface.

If the image processing unit 110 determines that the target page is the back surface of the carbonless copy paper (YES in step S604), the processing proceeds to step S605. In step S605, the image processing unit 110 determines whether the object subjected to the RIP processing has the text attribute. In other words, the image processing unit 110 determines the attribute of the print portion. If the image processing unit 110 determines that the object does not have the text attribute (NO in step S605), the processing proceeds to step S606. In step S606, the image processing unit 110 generates print image data on which the high density processing is performed with respect to the print portion of the target page. The high density processing is the image processing for applying high density toner to the input data of the print job and is different from the image processing applied to the entire print job.

In step S604, if it is determined that the target page is not the back surface of the carbonless copy paper (NO in step S604) or in step S605, if the image processing unit 110 determines that the object has the text attribute (YES in step 5605), the processing proceeds to step S607. In step S607, the image processing unit 110 generates print image data, which is subjected to the image processing to be applied to the entire print job, to the print portion of the target page.

In step S608, when the image processing of the target page ends, the image processing unit 110 determines whether the target page is the last page of the print job.

If the image processing unit 110 determines that the target page is the last page (YES in step S608), the processing proceeds to step S609. In step S609, the image processing unit 110 ends the RIP processing to the print job. On the other hand, in step S608, if the image processing unit 110 determines that the target page is not yet the last page (NO in step S608), the processing returns to step S604 and the RIP processing of the print job is continued.

After the RIP processing ends, in step S610, the image forming unit 111 executes the printing of the print image data generated by the image processing unit 110 on the sheet, and then the control processing of the printing apparatus 102 ends.

According to the above-described configuration, the printing apparatus 102 can appropriately block the copying in the copy-inhibited area by sufficiently applying the toner to an area on the back surface of the sheet corresponding to the area where copying to subsequent pages is inhibited in the set of carbonless copy paper.

Further, according to the above-described configuration, the processing can be changed according to the object in the area corresponding to the back surface of the print sheet. Since the processing is not applied to the input data whose attribute is not related to intentionally blocking the copying, printing can be performed according to optimum image processing designated by the print job.

Next, a third exemplary embodiment of the present invention will be described. According to the present exemplary embodiment, the points different from the first exemplary embodiment will be mainly described and descriptions of similar portions are not repeated.

The printing apparatus 102 may be configured to use toner of a single color (e.g., black toner) and to use toner of various colors (e.g., cyan, magenta, yellow, and black). With respect to a certain print portion, the printing apparatus 102 in the former case can apply the toner of up to 100% (i.e., the maximum value of allowable application amount for one toner) and, the printing apparatus 102 in the latter case can apply the toner of up to 400% (i.e., a total of the maximum values of the allowable application amount for the a plurality of types of toner).

Thus, according to the present exemplary embodiment, in addition to the processing according to the first exemplary embodiment, if the printing apparatus 102 can use toner of a plurality of types, the toner application amount is calculated by the image processing unit 110 according to the analysis of the print job and an amount greater than the calculated amount of toner will be applied to the page by using toner of the plurality of types. Since the amount of toner applied to the page is increased, the printing apparatus 102 can further firmly block the copying.

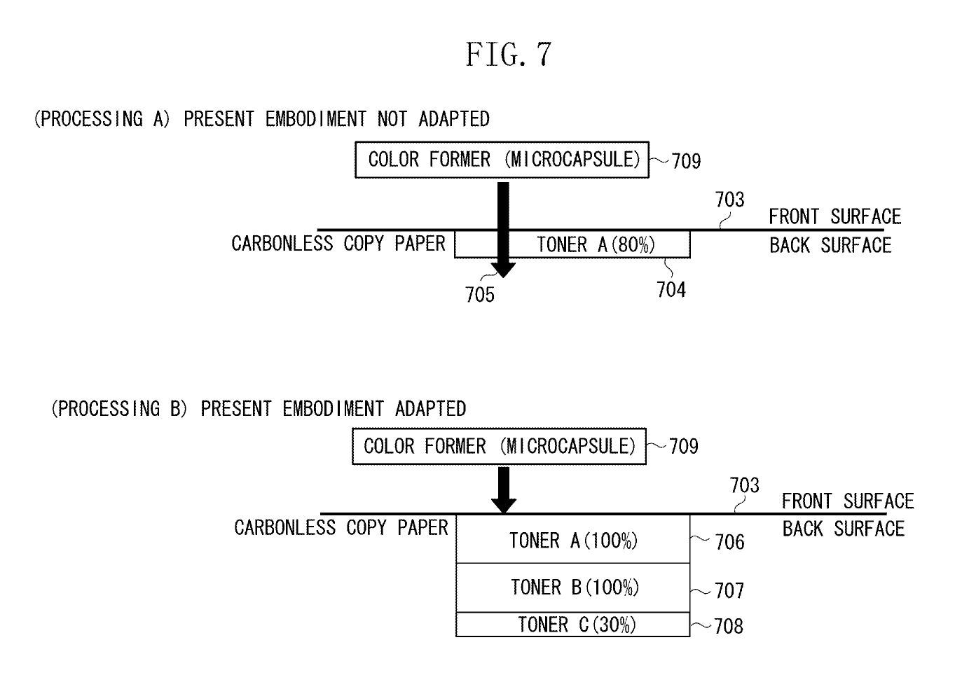

FIG. 7 illustrates an example of the copy mechanism of the carbonless copy paper. The processing A illustrates an example in which the present exemplary embodiment is not applied. The processing B illustrates an example of the copy mechanism according to the present exemplary embodiment. Regarding the processing A, the image processing unit 110 performs the image processing based on the received print job on the entire job regardless of whether the front or the back surface of the carbonless copy paper 703.

For example, if the toner save function is designated by the print job, the image processing unit 110 generates print image data on which the image processing that the toner application amount is reduced in the entire print job is performed. Then, the image forming unit 111 forms an image according to the print image data and applies toner A 704 to the copy limited area.

According to the present exemplary embodiment, it is assumed that the toner application amount reduced by the toner save function is 20%. Thus, if the input image signal of the print job is 100%, the final amount of toner application will be 80%. In addition to the toner save function, the processing that reduces the toner application amount may include gradation correction processing, noise reduction processing, smoothing processing, color space conversion processing, and the like. Thus, the processing that reduces the toner is not limited to particular processing in the present exemplary embodiment.

Since the toner A 704 finally applied to the page is 80% according to the processing A, the amount of toner is not enough in completely blocking an achromatic dye 705 according to the above-described principle. As a result, some color former passes through the toner layer and chemically reacts with the developer of the next and subsequent carbonless copy paper.

On the other hand, regarding the processing B, if it the sheet to be processed is determined as the back surface of the carbonless copy paper, the reduction processing of the toner application, which is one of the image processing performed for the entire print job, will not be performed on the relevant surface of the paper. Thus, print image data for image processing of high density toner application is generated. Further, not only toner of a single color A 706 is used but toner B 707 and toner C 708 of different colors are also used. In the description of the present exemplary embodiment below, the toner A 706 is black toner, the toner B 707 is cyan toner, and the toner C 708 is magenta toner.

The printing apparatus 102 is capable of using yellow toner. Thus, according to simple calculation, toner of a total of 400% can be applied to one area. However, due to toner fixing ability, not all of the printing apparatuses 102 can apply toner of 400%. Thus, regarding the description of the present exemplary embodiment, the maximum toner application of the printing apparatus 102 is set to 230%.

In the processing B, the image processing corresponding to the toner save function is not applied to the back surface of the carbonless copy paper. However, since toner of a total of 230% is applied to the back surface by the image forming unit 111, a color former 709 cannot pass the toner layers of the toner A 706, the toner B 707, and the toner C 708. Accordingly, copying can be reliably blocked.

According to the configuration described above, the printing apparatus 102 can appropriately block the copying in the copy-inhibited area by sufficiently applying the toner to an area on the back surface of the sheet corresponding to the area where copying to subsequent pages is inhibited in the set of carbonless copy paper.

Further, according to the above-described configuration, if the printing apparatus 102 is capable of using a plurality types (colors) of toner, the plurality types of toner is used in such a manner that the amount of the plurality types of toner will be increased compared to the toner application amount which is calculated according to analysis of the print job. Thus, the copying can be strictly blocked.

Next, a fourth exemplary embodiment of the present invention will be described. According to the present exemplary embodiment, the points different from the first exemplary embodiment will be mainly described and descriptions of similar portions are not repeated.

Regarding copy blocking in a specified area according to application of toner to carbonless copy paper, the color of the toner to be applied is not necessarily the color designated by the print job. In other words, since the toner is used for the purpose of copy blocking, toner of a different color may also be used in some cases. Thus, if toner of a color different is remained more, or if cost of such toner is lower, or if block performance of such toner is higher, than the toner designated in the print job, such toner will be used according to the present exemplary embodiment. Thus, according to the present exemplary embodiment, in addition to the processing according to the first exemplary embodiment, when print image data is generated, the toner type is not limited to the toner calculated from the print job and an arbitrary toner type can be used in place of the designated toner on the back surface of carbonless copy paper.

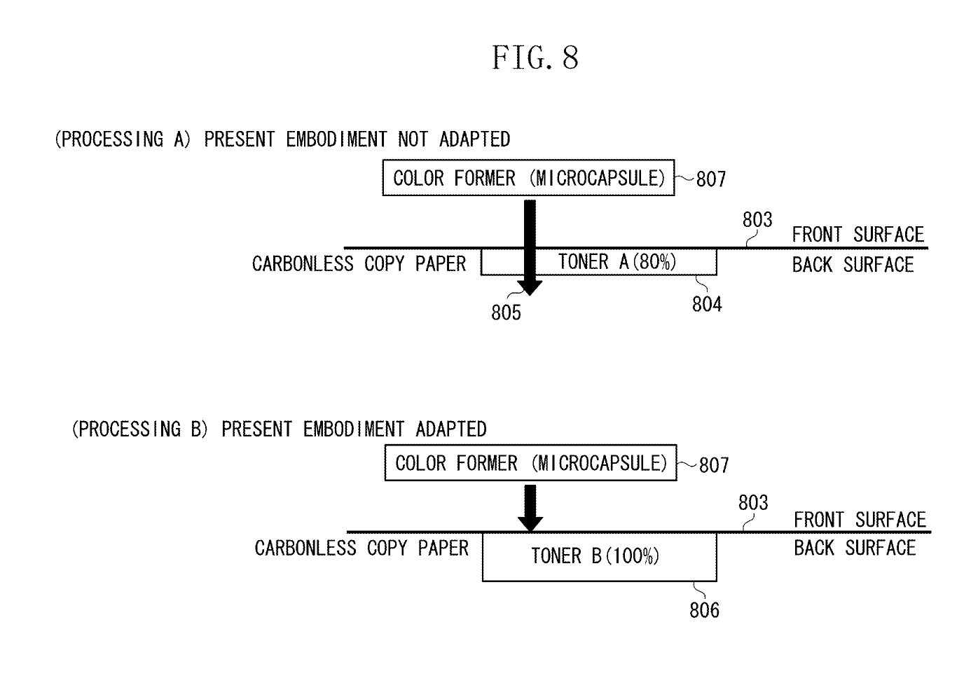

FIG. 8 illustrates an example of the copy mechanism of the carbonless copy paper. The processing A illustrates an example in which the present exemplary embodiment is not applied. The processing B illustrates an example of the copy mechanism according to the present exemplary embodiment. According to the processing A, the image processing unit 110 performs the image processing based on the received print job on the entire job regardless of whether the front or the back surface of the carbonless copy paper 803.

For example, if the toner save function is designated by the print job, the image processing unit 110 generates print image data on which the image processing that the toner application amount is reduced in the entire print job is performed. Then, the image forming unit 111 forms an image according to the print image data and applies toner A 804 to the copy limited area.

According to the present exemplary embodiment, it is assumed that the toner application amount reduced by the toner save function is 20%. Thus, if the input image signal of the print job is 100%, the final amount of toner application will be 80%. In addition to the toner save function, the processing that reduces the toner application amount may include gradation correction processing, noise reduction processing, smoothing processing, color space conversion processing, and the like. Thus, the processing that reduces the toner is not limited to particular processing in the present exemplary embodiment.

Since the toner A 804 finally applied to the page is 80% according to the processing A, the amount of toner is not enough in completely blocking the achromatic dye 805 according to the above-described principle. As a result, some color former passes through the toner layer and chemically reacts with the developer of the next and subsequent carbonless copy paper.

On the other hand, regarding the processing B, if it the sheet to be processed is determined as the back surface of the carbonless copy paper, the reduction processing of the toner application, which is one of the image processing performed for the entire print job, will not be performed on the relevant surface of the paper. Thus, print image data for image processing of high density toner application is generated. Further, according to the processing B, the toner may be changed from the toner A 804 designated in the print job to a different type of toner (toner B 806).

In other words, according to the processing B, the image processing corresponding to the toner save function is not applied to the back surface of the carbonless copy paper. Further, since an amount of 100% of the toner B 806 is applied by the image forming unit 111, the color former 807 cannot pass through the toner layer of the toner B 806, and copying can be firmly blocked.

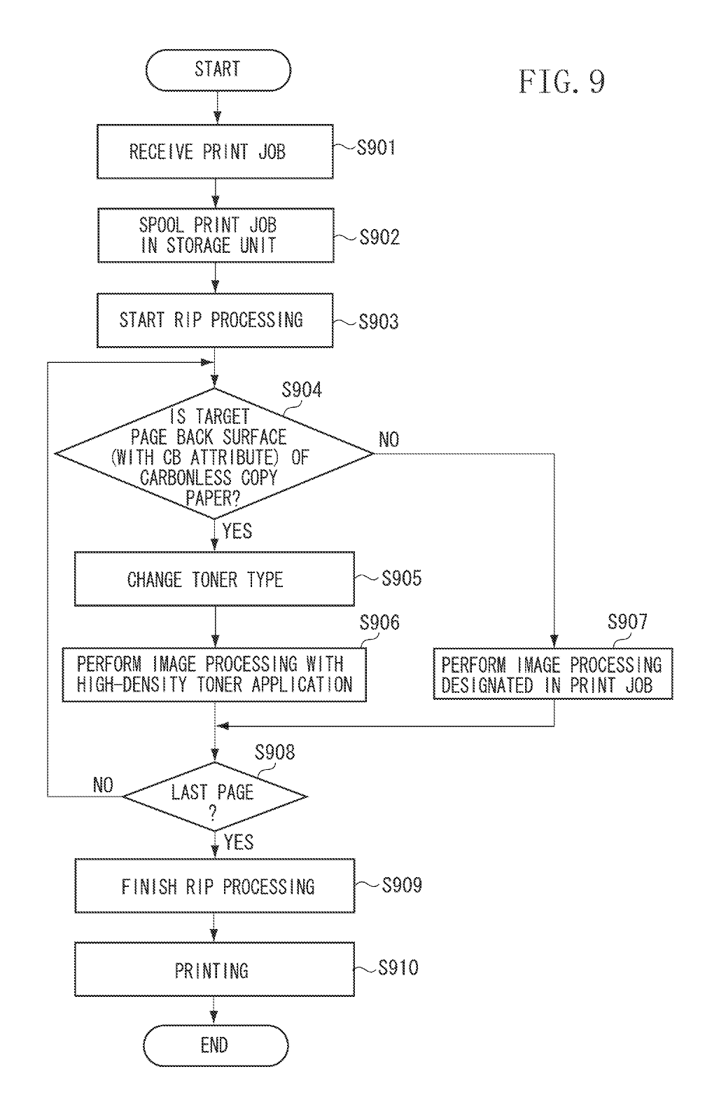

FIG. 9 is a flowchart illustrating an example of print control processing of the printing apparatus 102.

In step S901, the image processing unit 110 receives a print job from the host computer 101 via the network I/F 106 and the control processing is started. In step S902, the image processing unit 110 temporarily spools the print job received from the host computer 101 in the storage unit 109.

In step S903, the print processing is started and the image processing unit 110 starts the RIP processing.

In step S904, the image processing unit 110 determines whether the target page subjected to the RIP processing is the carbonless copy paper and the side of the carbonless copy paper is the back surface.

If the image processing unit 110 determines that the target page is the back surface of the carbonless copy paper (YES in step S904), the processing proceeds to step S905. In step S905, the image processing unit 110 changes the toner type from the one designated in the print job to an arbitrary toner type. In step S906, the image processing unit 110 generates print image data on which the high density processing is performed with respect to the print portion of the target page. The high density processing is the image processing for applying high density toner to the input data of the print job and is different from the image processing applied to the entire print job.

In step S904, if it is determined that the target page is not the back surface of the carbonless copy paper (NO in step S904), the processing proceeds to step S907. In step S907, the image processing unit 110 generates print image data, which is subjected to the image processing to be applied to the entire print job, to the print portion of the target page.

In step S908, when the image processing of the target page ends, the image processing unit 110 determines whether the target page is the last page of the print job.

If the image processing unit 110 determines that the target page is the last page (YES in step S908), the processing proceeds to step S909. In step S909, the image processing unit 110 ends the RIP processing to the print job. On the other hand, in step S908, if the image processing unit 110 determines that the target page is not yet the last page (NO in step S908), the processing returns to step S904 and the RIP processing of the print job is continued.

After the RIP processing ends, in step S910, the image forming unit 111 executes printing of the print image data generated by the image processing unit 110 on the sheet, and then the control processing of the printing apparatus 102 ends.

According to the above-described configuration, the printing apparatus 102 can appropriately block the copying in the copy-inhibited area by sufficiently applying the toner to an area on the back surface of the sheet corresponding to the area where copying to subsequent pages is inhibited in the set of carbonless copy paper.

Further, according to the above-described configuration, image data for the back surface of the carbonless copy paper can be generated while changing the toner type from the one designated by the print job to an arbitrary toner type.

In this manner, basically, regarding a print job or a page where an attribute of the carbonless copy paper is designated as a print sheet type, with respect to the page that corresponds to the back surface of the print sheet, image processing that prevents the blocking of the copying will not be performed.

Further, according to the above-described configuration, since high density toner application can be realized, the copying in the copy area can be firmly blocked.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-022013 filed Feb. 3, 2011, which is hereby incorporated by reference herein in its entirety.

What is claimed is:

1. A printing apparatus comprising:
a generation unit configured to identify a print area of a sheet on which a copy material is provided based on a print job, and, regarding the print area, generate image data subjected to other image processing which is other than image processing to be applied to the entire print job and in which an usage amount of a color material applied to the print area is not smaller than a defined value; and
a forming unit configured to form an image in the print area by applying the color material according to the image data.

2. The printing apparatus according to claim 1, wherein the generation unit identifies an attribute of an object in the print area, and generates image data subjected to the other image processing if the attribute of the object is not a defined attribute.

3. The printing apparatus according to claim 1, wherein a plurality types of color materials is provided as the color material,
wherein the defined value is a maximum value of an allowable usage amount of one color material, and
wherein the generation unit generates image data subjected to image processing that increases the usage amount of the color material applied to the print area from the defined value by combining the plurality types of color materials as the other image processing.

4. The printing apparatus according to claim 1, wherein a plurality types of color materials is provided as the color material, and
wherein the generation unit generates image data subjected to the other image processing by changing the type of color material designated by the print job to a type of color material different from the designated type.

5. A method for printing, the method comprising:
identifying a print area of a sheet on which a copy material is provided based on a print job, and, regarding the print area, generating image data subjected to other image processing which is other than image processing to be applied to the entire print job and in which an usage amount of a color material applied to the print area is not smaller than a defined value; and
forming an image in the print area by applying the color material according to the image data.

6. A program causing a computer to function as:
a generation unit configured to identify a print area of a sheet on which a copy material is provided based on a print job, and, regarding the print area, generate image data subjected to other image processing which is other than image processing to be applied to the entire print job and in which an usage amount of a color material applied to the print area is not smaller than a defined value; and
a forming unit configured to form an image in the print area by applying the color material according to the image data.
